(19) United States
(12) Patent Application Publication
(10) Pub. No.: US 2026/0008628 A1
(43) Pub. Date: Jan. 8, 2026

(54) GUIDE PIN RECEIVING DEVICE FOR CONVEYOR BELT CARTRIDGE CLEANER

(71) Applicant: Flexible Steel Lacing Company, Downers Grove, IL (US)

(72) Inventor: Mark Gerald Tomandl, Cedar Springs, MI (US)

(21) Appl. No.: 19/258,589

(22) Filed: Jul. 2, 2025

Related U.S. Application Data
(60) Provisional application No. 63/667,549, filed on Jul. 3, 2024.

(51) Int. Cl. B65G 45/16

(52) U.S. Cl. CPC B65G 45/16

(57) ABSTRACT

A guide pin receiving device is provided for facilitating installation and removal of a removable cartridge cleaner from a support member of a conveyor belt cleaner system. The guide pin receiving device includes a retention slot for receiving a guide pin of one of the cartridge and support member therein. The retention slot is formed by an upper arm portion and a lower spring arm portion that is allowed to resiliently shift when engaged with the guide pin. The upper arm portion and the spring arm portion include opposing guide surfaces for guiding the guide pin to a seating location within the retention slot. The retention slot may have a tapered configuration extending from a larger open end for receiving the guide pin, to a narrower inner end where the guide pin is seated at the seating location with the cartridge in an installed configuration.

### CROSS-REFERENCE TO RELATED APPLICATION

This application claims the benefit of U.S. Provisional Patent Application No. 63/667,549, filed Jul. 3, 2024, the contents of which are incorporated herein by reference as if fully rewritten herein.

### TECHNICAL FIELD

This disclosure relates generally to conveyor belts, and more particularly, to components for securing cleaner cartridges.

### BACKGROUND OF THE INVENTION

Conveyor belt systems may be used to transport conveyed materials such as coal or aggregate from one location to another and include various components, such as conveyor belts, chutes, and rollers. Material not discharged by the conveyor belt may remain on the conveyor belt along the return side of the belt. Such carryback of material is typically undesirable, often necessitating additional site maintenance and potentially causing problems with the conveyor system. As such, conveyor belt cleaners are often utilized to remove residual material from the conveyor belt.

A conveyor belt cleaner may include one or more scraper blades operatively mounted to an elongated support member, such as a support shaft, that extends laterally across the belt with the scraper blades biased into engagement with the surface of the conveyor belt. The scraper blades scrape away residual material as the conveyor belt moves past the belt cleaner. Installation and removal of a cartridge having the scraper blades connected thereto may include sliding the cartridge along the elongate support member between fully engaged and fully disengaged positions. Example conveyor belt cleaning assemblies are described in U.S. Pat. No. 11,878,874, entitled “Conveyor Belt Cleaning System,” which is hereby incorporated by reference as if fully set forth herein.

### SUMMARY

In accordance with one aspect of the invention, a guide pin receiving device for a conveyor belt cleaner system is provided that allows for faster and easier installation of a removable cartridge cleaner on an elongate support member of a belt cleaner system and improves the operation of the belt cleaner system. In prior approaches, guide pin retention members for receiving guide pins of removable cartridge cleaners have rigid bodies such that the guide pin retention slots of the retention members are also rigid. In such approaches, cartridges must be installed such that the guide pins are inserted into the guide pin retention slots with a relatively high degree of precision to ensure proper seating of the guide pins within the slots, both vertically in the Z direction and laterally across the belt and along the elongate support shaft in the Y direction. Properly inserting and seating the guide pins in the retention slots often requires manual intervention during installation, such as hammering of the guide pins into place. Furthermore, such rigid guide pin retention members cannot accommodate variations in guide pin dimensions, which can also change over time due to accumulation of foreign matter such as rust or debris, causing outer dimensions of the guide pins to increase.

As will be appreciated, the guide pin receiving devices described herein, also referred to as pin captures, allow for increased flexibility during installation of a cartridge cleaner on a support shaft. The guide pin receiving devices include a resilient spring arm portion that is allowed to shift or deflect when receiving a guide pin in the retention slot of the guide pin receiving device, thereby increasing tolerances relating to the positioning and size of the guide pin, as well as the positioning of the guide pin receiving device itself on the support shaft or the cartridge. The spring arm portion defines the retention slot with an upper arm portion of the guide pin receiving device for receiving the guide pin. The retention slot includes an opening between an outer free end portion of the upper arm portion and the spring arm portion to allow a guide pin to be received in the retention slot and to allow the received guide pin to be biased into engagement with the upper arm portion. The guide pin receiving device advantageously self-adjusts to different relative positions and/or sizes of the guide pin and guide pin receiving device and thereby inhibits movement of the cartridge relative to the support shaft during a conveyor belt cleaning operation due to contact of scraper blades with the conveyor belt, improving stability of the conveyor belt cleaner system and reducing noise and wear.

In another aspect of the invention, a conveyor belt cleaner system includes an elongate support member for extending longitudinally across a conveyor belt and a cartridge for supporting at least one scraper blade thereon, the cartridge being slidable over the elongate support member. The cartridge includes a pair of side walls depending from either side of an upper wall to space the side walls for receiving the elongate support member therebetween. At least one guide pin receiving device is attached to one of the elongate support member and an inner facing surface of one of the pair of side walls of the cartridge. The guide pin receiving device includes a body having an upper arm portion extending between an outer free end portion and an inner end portion, a lower arm portion of the body extending to an outer free end portion thereof, and a spring arm portion of the body between the upper arm portion and the lower arm portion. The spring arm portion and the upper arm portion form a retention slot therebetween that includes an opening between the outer free end portion of the upper arm portion and the spring arm portion to allow a guide pin to be received in the retention slot and to allow the received guide pin to be biased into engagement with the upper arm portion. A guide pin for being received in the retention slot is attached to the other of the elongate support member and the inner facing surface of one of the pair of side walls of the cartridge and is positioned for being received in the retention slot of the at least one guide pin receiving device with the cartridge supported on the elongate support member in an installed configuration of the cartridge.

### BRIEF DESCRIPTION OF THE DRAWINGS

FIG. 1 is a schematic view of a portion of a conveyor system showing a conveyor belt passing over a pulley and a cleaning assembly adjacent the conveyor belt with scraper blades biased out of engagement with the conveyor belt.

FIG. 2 is a perspective view of the cleaning assembly showing a cartridge carrying scraper blades and secured to a support shaft in the operative position of the cartridge with the support shaft mounted at either end thereof to tensioners.

FIG. 3 is an exploded, perspective view of the cartridge and a support assembly showing a main elongate shaft portion of the support assembly having a square cross-sectional configuration and a blade carrying member of the cartridge having an inverted generally U-shaped configuration.

FIG. 4 is a side elevation view of two central retention members secured to a support rail of a cartridge in opposite orientations for receiving protrusions of respective cartridges.

FIG. 5 is a perspective view of a central retention member showing upper and lower arm portions, a flexible spring arm portion extending therebetween to form a retention slot with the upper arm portion, and a stop surface of the lower arm portion for limiting deflection of the spring arm portion.

FIG. 6 is a cross-sectional view of a cartridge installed on a support rail with the support rail having central retention members secured at outwardly-facing surfaces of the support rail and projections secured at inwardly-facing surfaces of the support rail.

FIG. 7 is a cross-sectional view of a cartridge installed on a support rail with the cartridge having central retention members secured at inwardly-facing surfaces of the cartridge, and projections secured at outwardly-facing surfaces of the support rail.

### DETAILED DESCRIPTION

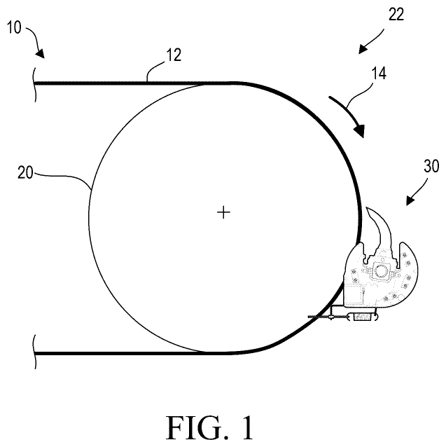

As shown in FIG. 1, a conveyor belt system 10 includes a conveyor belt 12 in the form of a continuous belt. The conveyor belt 12 travels along a travel path 14 over a rotatable pulley 20 at an end portion 22 of the conveyor belt system 10. The pulley 20 may be a head pulley that is connected to a power source such as a motor that drives the pulley 20, which in turn acts upon the conveyor belt 12 so it travels around the pulley 20. Material carried by the belt 12 can be discharged at the head pulley 20 as the belt 12 travels around the pulley 20.

The conveyor belt system 10 includes one or more belt cleaners positioned so that scraper blades thereof can be shifted into engagement with the conveyor belt 12 so as to remove material from the conveyor belt 12 as the belt moves along the path 14. The belt cleaners may include one or more pre-cleaner or primary belt cleaners 30 positioned at the pulley 20 to assist in discharging material from the conveyor belt 12. The use of more than one primary belt cleaner 30 at the pulley 20 reduces the amount of carryback material carried along the return run of the conveyor belt 12. The conveyor belt system 10 may also or instead include one or more secondary belt cleaners positioned along the lower return run of the conveyor belt 12 to provide additional cleaning of the conveyor belt 12.

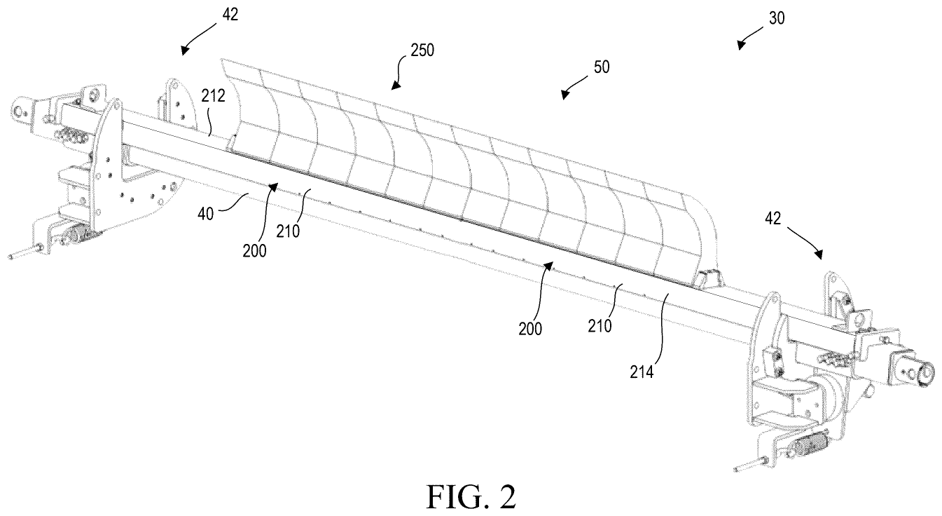

Referring to FIG. 2, an example of a cartridge belt cleaner 30 is provided. The cartridge cleaner 30 is similar to the belt cleaner disclosed in U.S. Pat. No. 11,878,874 B2, which is hereby incorporated by reference as if reproduced in its entirety herein. The cartridge belt cleaner 30 may be a primary cleaner positioned adjacent a head pulley. The belt cleaner 30 includes an elongate support member such as support shaft 40 that extends between opposing tensioners 42, and a scraper assembly 50 that is supported by the support shaft 40. The tensioners 42 can be configured to both support and bias the support shaft 40 and the scraper assembly 50 to keep the scraper blades in resilient engagement with the belt while allowing them to temporarily shift away from the belt when encountering obstructions such as when belt splices travel past the scraper blades.

The scraper assembly 50 is preferably sized to include two cartridges 200 for being installed on the support shaft 40 from either end thereof. The cartridges 200 may be mirror images of each other with substantially the same features. Each cartridge 200 includes a scraper blade carrier member such as a support rail 210. Scraper blades 250 are secured to a flat upper web or wall 212 of the support rail 210.

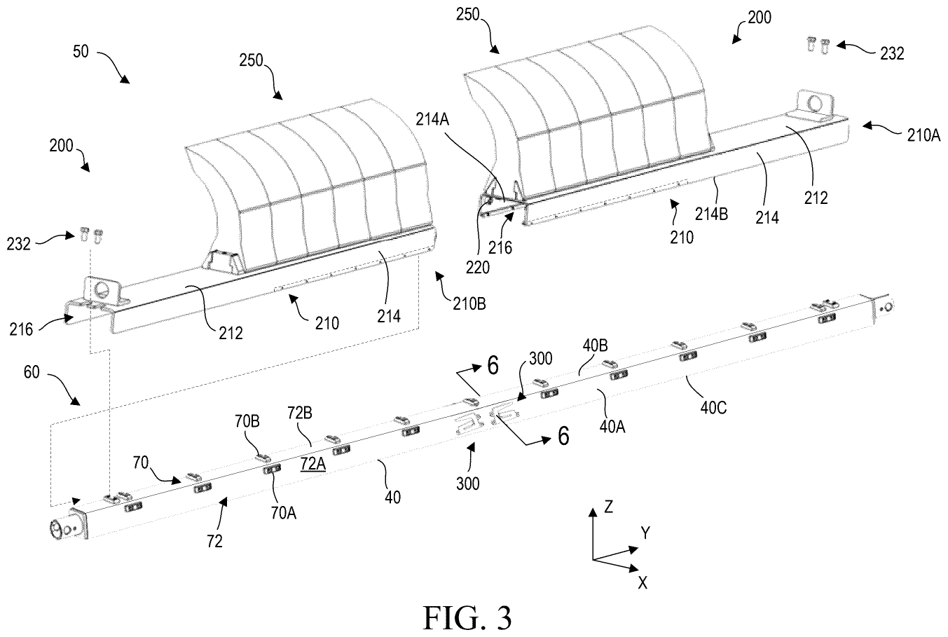

Referring to FIG. 3, a support assembly 60 of the belt cleaner 30 is shown with the scraper assembly 50 removed from the support assembly 60. The support assembly 60 includes the support shaft 40, which has a main elongate shaft portion having a cross-section that preferably is generally square or rectangular so as to have flat walls and corresponding surfaces thereof extending thereabout.

The support rails 210 further include a pair of flat side walls or legs 214 that depend or extend vertically downwardly from the upper wall 212 along the length thereof. The side legs 214 are generally symmetrically spaced from a center of the upper wall 212. The upper wall 212 and side legs 214 cooperate to form an elongate channel 216 therebetween sized for receiving a portion of the support shaft 40 therebetween so that the side legs 214 extend down alongside the support shaft 40 when in the operative installed position thereon to retain the support rails 210 on the support shaft 40. The side legs 214 depend vertically downwardly along less than an entire height of the support shaft 40 to a bottom end 214B that is above a bottom end 40C of the support shaft 40, and are each spaced from a facing corresponding sidewall 72A of the support shaft 40. In this way, debris that may accumulate between the support rail 210 and the support shaft 40 may fall freely between and out from the bottom of the spaces or gaps between the side legs 214 and the support shaft 40.

The support assembly 60 includes at least one slide block 70 secured to an outward facing surface of a side wall 72 of the main shaft portion of the support shaft 40. For example, the support assembly 60 may include one or more guide members or side slide blocks 70A secured to opposite outer surfaces of lateral sidewalls 72A of the main portion of the support shaft 40. The side slide blocks 70A space the side legs 214 of the support rail 210 of the cartridge 200 from the outer side walls of surfaces 40A of the support shaft 40 and guide sliding of the side legs 214 along the support shaft 40 during installation of the cartridge 200 on the support shaft 40.

Additionally or alternatively, the support assembly 60 includes one or more upper slide blocks 70B secured to the outer surface of the upper wall 72B of the main portion of the support shaft 40. The upper slide blocks 70B space the upper wall 212 of the support rail 210 of the cartridge 200 from the upper wall or surface 40B of the support shaft 40 and support the weight of the cartridge 200 on the support shaft 40. The slide blocks 70 are formed of a low friction material to facilitate sliding of a cartridge 200 of the scraper assembly 50 relative to the support shaft 40 during installation and removal of the cartridge 200. During installation of a cartridge 200, the cartridge 200 slides along the slide blocks 70A, 70B and pushes any debris off of the slide blocks 70A, 70B. As the cartridge 200 forms a generally inverted U-shaped configuration that does not have a bottom portion extending below the support shaft 40, debris that is pushed off the side slide blocks 70A freely falls through the gaps between side slide blocks 70A and down to a floor surface below the belt cleaner 30.

With the cartridge 200 properly aligned on the support assembly 60, fasteners such as bolts 232 may secure the outer end portion 210A of the support rail 210 to the support shaft 40 to restrict movement of the outer end portion 210A. As such, the support rail 210 may be positively anchored at the outer end portion 210A.

The support rail 210 may also be secured to the support shaft 40 at the inner end portion 210B by projections in the form of guide bosses or guide pins 220 that extend generally perpendicularly to the length of support rail 210 in an inward direction toward the support shaft 40. The support assembly 60 includes central retention members such as pin captures 300 that are secured to sidewalls 72A of the support shaft 40 centrally along the length of the support shaft 40. As shown, the support shaft 40 includes two pin captures 300 having oppositely-facing retention slots 310 for retaining and supporting inner portions 210B of the of the support rail 210 of the cartridge 200. More particularly, the pin captures 300 receive and retain the pins 220 in their slots 310 with the pins 220 being secured to inner surfaces 214A of the side legs 214 of the support rail 210, as discussed greater detail herein. The pins 220 are secured to the inner surfaces 214A, for example, by welding or mechanical fasteners. As such, the pins 220 are received by the pin captures 300 in the covered space or gap between the side legs 214 of the support rails 210 and the support shaft 40 to minimize any fouling or debris accumulation of these components that can change their tolerances making installation more difficult. Alternatively, the pin captures 300 still can be used advantageously with belt cleaners where they would be exposed such as in the cartridge belt cleaners disclosed in applicant's U.S. Pat. No. 7,987,966 B2, which is hereby incorporated by reference as if reproduced in its entirety herein. In those belt cleaners, the cartridge legs ride on the top of the support shaft so the pin captures 300 would be provided with a greater height dimension so the slots 310 thereof would be in general alignment with the guide pins of the cartridge.

As discussed above, in the prior approaches, central retention members for receiving guide pins are rigid bodies such that guide slots of the central retention members do not have any, or have very limited, degree of movement. In such approaches, cartridges must be installed such that the guide pins are inserted into the guide slots with a relatively high degree of precision to ensure proper seating of the guide pins-both vertically in the Z direction and laterally across the belt and along the elongate support shaft in the Y direction (see, e.g., FIG. 3)—within the slots. Difficulty properly inserting the guide pins often requires manual intervention during installation (e.g., hammering of the guide pins into place). Furthermore, such rigid bodies don't account for variations in guide pin dimensions. Nor do such rigid bodies account for changes in guide pin dimensions over time. For example, guide pins in certain conveyor belt environments may accumulate foreign matter such as rust or debris, causing outer dimensions of the guide pins to increase. As will be appreciated, the central retention members described here have a flexible spring arm portion that allows for deflection, thereby increasing tolerances during installation of a cartridge on a support shaft.

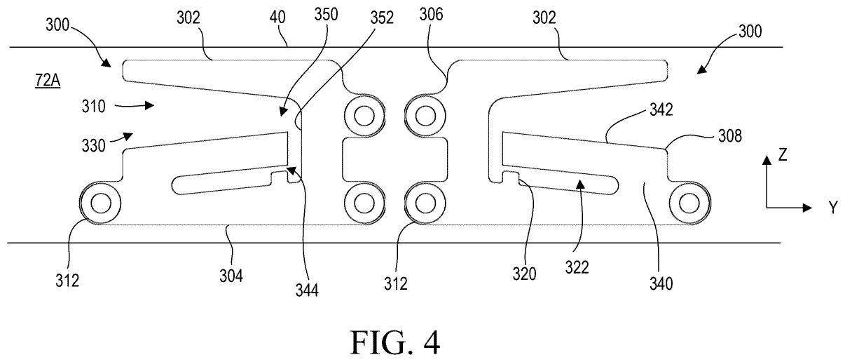

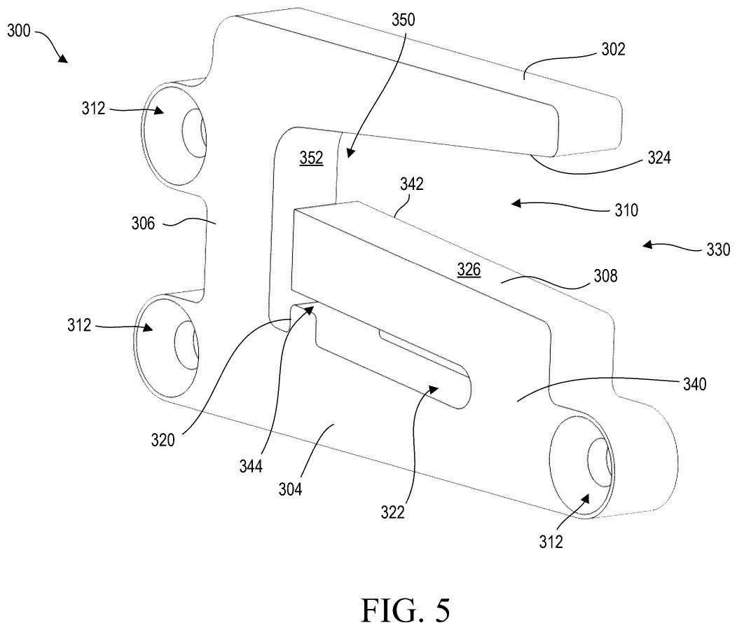

Referring to FIGS. 4 and 5, the guide pin receiving device or pin capture 300 includes a body including a laterally-extending upper arm portion 302, a laterally-extending lower arm portion 304, a transverse or vertical arm portion 306 that extends between inner ends of the upper arm portion 302 and the lower arm portion 304 at one lateral end of the pin capture 300, and a spring arm portion 308 that extends in an extension direction along the lower arm portion 304 and between the upper arm portion 302 and the lower arm portion 304 so that the spring arm portion and the upper arm portion 302 form or define the retention slot 310 therebetween. The retention slot 310 has a receiving portion or opening 330 between an outer free end portion of the upper arm portion 302 and the spring arm portion 308 to allow a guide pin to be received in the retention slot 310 and to allow the received guide pin to be biased into engagement with the upper arm portion 302. The opening 330 is located at the outer lateral end of the pin capture 300 opposite to the transverse or vertical arm portion 306. Although referred to herein as “upper” and “lower” arm portions, it is contemplated that the pin capture 300 may be rotated 180 degrees such the depicted “upper” arm portion is below the “lower” arm portion.

A pin capture 300 further includes a stop portion 320 that extends upwardly from the lower arm portion 304 (e.g., approximately 6.5 millimeters) into a gap 322 formed between the lower arm portion 304 and the spring arm portion 308 a toward a free end portion of the spring arm portion 308. The pin capture 300 may be of a unitary, one-piece, plate construction of steel (e.g., A36 or other mild steel, or stainless steel), plastic, or other suitable material that provides sufficient rigidity while also allowing for deflection of the spring arm portion 308, as will be discussed hereinafter.

The pin capture 300 further includes one or more (e.g., three) attachment interfaces 312 for securing the pin capture 300 to a sidewall 72A of the support shaft 40. The attachment interfaces 312 shown are in the form of through-holes for receiving fasteners. In other approaches, the attachment interfaces 312 may be, or may further include, weld locations.

The upper arm portion 302 includes a downwardly-facing guide surface 324 that extends obliquely inwardly along the retention slot 310, i.e., tapers downwardly from its free end at the opening to the retention slot 310 toward the spring arm portion 308 for guiding the guide pin 220 therealong within the retention slot. In this way, as a pin 220 of one of the cartridges 200 is shifted laterally along the downwardly-facing surface 324, the taper of the upper arm portion 302 acts to drive or cam the cartridge downwardly, ensuring a consistent, snug fit of the cartridge 200 on the support shaft 40, and specifically against the upper slide blocks 70B.

In the relaxed state, the spring arm portion 308 extends at an oblique angle transversely relative to the upper arm portion 302 within or along the retention slot 310. In this way, the downwardly-facing guide surface 324 of the upper arm portion 302 and an upwardly-facing opposing guide surface 326 of the spring arm portion 308 form or define upper and lower extents of a tapered retention slot 310 therebetween (e.g., forming approximately a 12 degree angle therebetween) with the opposing guide surfaces 324 and 326 tapering toward each other as they extend toward the transverse or vertical arm portion 306 at an inner end of the retention slot 310. The receiving portion or opening 330 of the retention slot 310 is oversized relative to the pin 220 and is larger than the inner end of the slot 310 so it more easily receives the pin 220 of the cartridge 200 between the downwardly-facing surface 324 of the upper arm portion 302 and the upwardly-facing surface 326 of the spring arm portion 308 during installation of the cartridge 200 despite any variations in the size or position of the pin 220.

The spring arm portion 302 includes a flexible joint portion 340 adjacent and below the slot opening 330 with the joint portion 340 extending generally vertically from the lower arm portion 304 and a main arm body portion 342 that extends generally laterally at an incline from the flexible joint portion 340. In the relaxed state, main arm body portion 342, and more particularly an inner free end portion thereof, is spaced from the stop portion 320 to form a tolerance gap 344 with the stop portion 320. The tolerance gap 344 may be, for example, approximately 2 millimeters. The flexible joint portion 340 allows for deflection or resilient shifting of the main arm body portion 342 of the spring arm portion 302 in a direction transverse to the extension direction thereof, i.e., downwardly into the tolerance gap 344 toward the stop portion 320. The deflection distance of the body portion 342 is limited by the height of the stop portion 320. In this way, the height of the stop portion 320 is selected such that flexing of the spring arm portion 302 does not exceed the yield strength of the material of the pin capture 300 at the flexible joint portion 340.

During installation of a cartridge 200, the cartridge 200 is slid along the support shaft 40 such that the pin projections 220 of the cartridge 200 are guided into the receiving portion 330 of the retention slot 310 of the pin capture 300 toward a target seating location 350 along an inner inclined surface 352 of the transverse or vertical arm portion 306.

When the projections 220 are inserted vertically higher than the target seating location 350, the projections 220 can engage the downwardly-facing inclined surface 324 of the upper arm portion 302. As discussed, engagement along the downwardly-facing surface 324 of the upper arm portion 302 urges inner portions 210B of the of the support rail 210 of the cartridge 200 downwardly. This downward urging causes the upper wall 212 of the support rail 210 to be securely and tightly engaged on or against individual ones of the upper slide blocks 70B of the support shaft 40.

When the pin projections 220 are inserted vertically lower than the target seating location 350, the projections 220 engage the upwardly-facing inclined surface 326 of the spring arm portion 308. Due to the construction of the spring arm portion 308, the spring arm portion 308 may not flex upon initial contact and may urge inner portions 210B of the support rail 210 of the cartridge 200 upwardly.

As the cartridge 200 is further slid toward the transverse or vertical arm portion 306, the pin projection 220 engages both the upper arm portion 302 and the spring arm portion 308. Engagement with both the upper arm portion 302 and the spring arm portion 308 desirably reduces rattle. As discussed, to ensure proper seating of the projections 220 within the target seating location 350 of the retention slot 310, the main arm body portion 342 of the spring arm portion 308 may flex downwardly about the flexible joint portion 340 and bias the guide pin or projection 220 into engagement with the upper arm portion 302.

The cartridges 200 are slid along the support shaft 40 until the projections 220 abut (or “bottom out” against) the inner surfaces 352 of the transverse or vertical arm portions 306, which block further axial or longitudinal sliding of the cartridges 200 along the Y axis. The upper arm portions 302 and the spring arm portions 308 cooperate with the transverse or vertical arm portions 306 to tightly retain the projections 220 therebetween to inhibit vertical movement (e.g., along the Z axis) of the inner end portion 210B of the support rail 210, as well as any tipping of the cartridges 200 during conveyor belt cleaning operations. In this way, the pin captures 300 cooperate with the projections 220 to anchor the inner end portions 210B to the support assembly 60. As discussed, bolts 232 may then be used to secure the outer end portion 210A of the support rail 210 to the support shaft 40 to restrict movement of the outer end portion 210A.

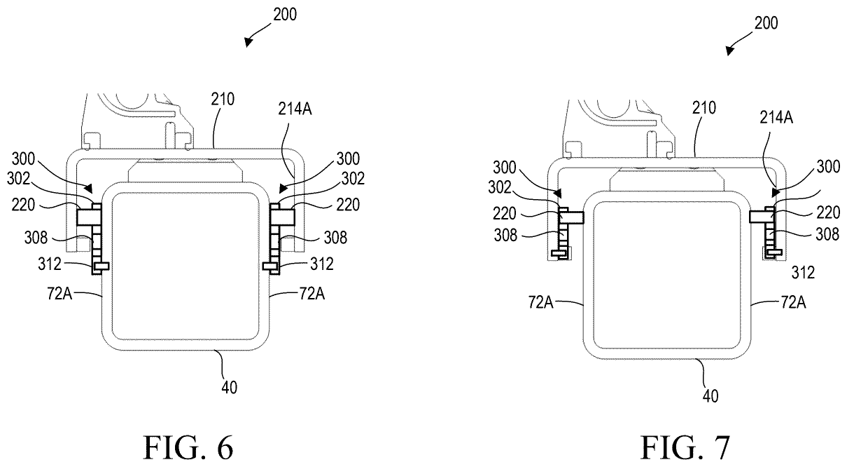

Referring to FIG. 6, as discussed herein, the projections 220 are secured to inner surfaces 214A of the side walls or legs 214 of the support rail 210, and the pin captures 300 are secured to a sidewall 72A of the support shaft 40. In another approach, shown in FIG. 7, the projections 220 may be secured to a sidewall 72A of the support shaft 40, and the pin captures 300 may be secured to inner surfaces 214A of the side legs 214 of the support rail 210 while providing the features and benefits described herein.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A guide pin receiving device for a conveyor belt cleaner system, comprising:
a body;
an upper arm portion of the body extending to an outer free end portion of the upper arm portion;
a lower spring arm portion of the body;
a retention slot between the upper arm portion and the lower spring arm portion; and
an opening of the retention slot between the outer free end portion of the upper arm portion and the spring arm portion to allow a guide pin to be received in the retention slot and to allow the received guide pin to be biased into engagement with the upper arm portion.

2. The guide pin receiving device of claim 1, wherein the body includes:
a lower arm portion extending to an outer free end portion; and
a stop portion extending transversely from the lower arm portion into a gap formed between the lower arm portion and the spring arm portion, the stop portion adjacent to and spaced from an inner free end portion of the spring arm portion for limiting resilient movement of the inner free end portion in a direction transverse to an extension direction of the spring arm portion.

3. The guide pin receiving device of claim 1, wherein the body includes:
a lower arm portion extending between an inner end portion and an outer free end portion; and
a transverse arm portion extending between an inner end portion of the upper arm portion and the inner end portion of the lower arm portion, wherein the transverse arm portion comprises an inner surface defining an inner end of the retention slot for engaging with the received guide pin.

4. The guide pin receiving device of claim 1, wherein the upper arm portion comprises a guide surface that extends obliquely inwardly along the retention slot toward the spring arm portion from the outer free end portion of the upper arm portion for guiding the guide pin therealong within the retention slot.

5. The guide pin receiving device of claim 4, wherein the spring arm portion comprises an opposing guide surface that extends obliquely inwardly along the retention slot toward the guide surface of the upper arm portion when the spring arm portion is in a relaxed state with the opposing guide surface of the spring arm portion and the guide surface of the upper arm portion defining lower and upper extents of the retention slot such that the retention slot has a tapered configuration with the opening of the retention slot being larger than an inner end of the retention slot.

6. The guide pin receiving device of claim 5, wherein the retention slot forms a 12-degree angle between the guide surface of the upper arm portion and the opposing guide surface of the spring arm portion.

7. The guide pin receiving device of claim 1, wherein the body includes a lower arm portion extending to an outer free end portion thereof; and
wherein the spring arm portion is connected to the outer free end portion of the lower arm portion via a flexible outer joint portion that allows the spring arm portion to resiliently shift in a direction transverse to an extension direction of the spring arm portion.

8. The guide pin receiving device of claim 1, wherein the body comprises at least one attachment interface for securing the body to a wall.

9. The guide pin receiving device of claim 8, wherein the at least one attachment interface comprises a through-hole for receiving a fastener.

10. The guide pin receiving device of claim 1, wherein the body is of a unitary, one-piece, plate construction.

11. A conveyor belt cleaner system, comprising:
an elongate support member for extending longitudinally across a conveyor belt;
a cartridge for supporting at least one scraper blade thereon, the cartridge slidable over the elongate support member;
wherein the cartridge comprises a pair of side walls depending from either side of an upper wall to space the side walls for receiving the elongate support member therebetween;
at least one guide pin receiving device attached to one of the elongate support member and an inner facing surface of one of the pair of side walls of the cartridge, the at least one guide pin receiving device comprising:
a body;
an upper arm portion of the body extending between an outer free end portion and an inner end portion of the upper arm portion;
a lower arm portion of the body extending to an outer free end portion thereof;
a spring arm portion of the body between the upper arm portion and the lower arm portion;
a retention slot between the spring arm portion and the upper arm portion; and
an opening of the retention slot between the outer free end portion of the upper arm portion and the spring arm portion to allow a guide pin to be received in the retention slot and to allow the received guide pin to be biased into engagement with the upper arm portion; and
a guide pin attached to another of the elongate support member and the inner facing surface of one of the pair of side walls of the cartridge positioned for being received in the retention slot of the at least one guide pin receiving device with the cartridge supported on the elongate support member in an installed configuration of the cartridge.

12. The conveyor belt cleaner system of claim 11, wherein the guide pin engages both the upper arm portion and the spring arm portion with the cartridge in the installed configuration.

13. The conveyor belt cleaner system of claim 11, wherein the spring arm portion is resiliently biased toward the lower arm portion by the guide pin when the guide pin is received in the retention slot with the cartridge in the installed configuration.

14. The conveyor belt cleaner system of claim 11, wherein the body of the at least one guide pin receiving device comprises a transverse arm portion extending between the inner end portion of the upper arm portion and an inner end portion of the lower arm portion, wherein the transverse arm portion comprises an inner surface defining an inner end of the retention slot for engaging with the guide pin when the cartridge is in the installed configuration.

15. The conveyor belt cleaner system of claim 11, wherein the at least one guide pin receiving device comprises first and second guide pin receiving devices, wherein the first and second guide pin receiving devices are attached to the elongate support member adjacent to one another with the respective openings thereof facing toward opposite ends of the elongate support member.

16. The conveyor belt cleaner system of claim 11, wherein the at least one guide pin receiving device comprises first and second guide pin receiving devices, wherein the first and second guide pin receiving devices are respectively attached to opposing inner surfaces of the pair of side walls of the cartridge.

17. The conveyor belt cleaner system of claim 11, wherein the body of the at least one guide pin receiving device further comprises a stop portion extending transversely from the lower arm portion into a gap formed between the lower arm portion and the spring arm portion, the stop portion adjacent to and spaced from a free end portion of the spring arm portion for limiting resilient movement of the free end portion in a direction transverse to an extension direction of the spring arm portion.

18. The conveyor belt cleaner system of claim 11, wherein the elongate support member comprises a plurality of slide blocks attached to an upper facing surface thereof, wherein the upper arm portion of the at least one guide pin receiving device comprises a guide surface that extends obliquely inwardly along the retention slot toward the spring arm portion from the outer free end portion of the upper arm portion for guiding the guide pin therealong within the retention slot to urge the upper wall of the cartridge against individual ones of the plurality of slide blocks.

19. The conveyor belt cleaner system of claim 18, wherein the spring arm portion comprises an opposing guide surface that extends obliquely inwardly along the retention slot toward the guide surface of the upper arm portion when the spring arm portion is in a relaxed state with the opposing guide surface of the spring arm portion and the guide surface of the upper arm portion defining lower and upper extents of the retention slot such that the retention slot has a tapered configuration with the opening of the retention slot being larger than an inner end of the retention slot.

20. The conveyor belt cleaner system of claim 11, wherein the spring arm portion is connected to the outer free end portion of the lower arm portion via a flexible outer joint portion of the body that allows the spring arm portion to resiliently shift toward the lower arm portion.
